(19) United States
(12) Patent Application Publication
(10) Pub. No.: US 2024/0371359 A1
(43) Pub. Date: Nov. 7, 2024

(54) Dialogue Localisation

(71) Applicant: Sony Interactive Entertainment Europe Limited, London (GB)

(72) Inventors: Lloyd Stemple, London (GB); Juuso Tolonen, London (GB)

(73) Assignee: Sony Interactive Entertainment Europe Limited, London (GB)

(21) Appl. No.: 18/641,535

(22) Filed: Apr. 22, 2024

(30) Foreign Application Priority Data
May 4, 2023 (GB) GB2306599.8

(51) Int. Cl. G10L 13/08; G06F 40/58; G06T 13/20; G06T 13/40

(52) U.S. Cl. CPC G10L 13/08; G06F 40/58; G06T 13/205; G06T 13/40

(57) ABSTRACT

The invention includes a computer-implemented method of determining a required length of a scene comprising a speaking character, wherein the scene is localized in multiple spoken languages, the method comprising: obtaining a script for the speaking character in a first language; automatically translating the script into one or more second languages; performing text-to-speech processing to generate a localized audio sample for the script in each of the first language and the one or more second languages; determining a duration of the localized audio sample in each of the first language and the one or more second languages; and determining a maximum spoken duration of the script as the maximum of the respective durations of the localized audio sample in each of the first language and the one or more second languages.

### CROSS-REFERENCE TO RELATED APPLICATION

The present application claims priority from United Kingdom Patent Application No. GB2306599.8, filed May 4, 2023, the disclosure of which is hereby incorporated herein by reference.

### FIELD OF THE INVENTION

The invention relates to voice-overs for media such as video games and animations. In particular the invention relates to media where multiple voice-over languages are provided.

### BACKGROUND

Increasingly, media companies such as game publishers and video streaming services offer their services internationally, across multiple language barriers. In order to make a game or other media accessible to local audiences, localization is performed. Herein, localization means translation of spoken components of media into a local language, and integration of the translated dialogue with other components of the media such as animations and background music. Localization may also include translation of subtitles or surtitles.

Localization is typically not performed until after the media has been completed in an original language. A challenge that can arise from such a process is that the foreign language localisation must fit with the existing video components or animations, and it can be necessary to change the content of the dialogue in the foreign language in order to achieve this fit.

### SUMMARY

In view of the above problem, the inventors have identified that it would be useful to anticipate the time required for localized dialogue at an early stage in media production.

According to a first aspect, there is provided a computer-implemented method of determining a required length of a scene comprising a speaking character, wherein the scene is localized in multiple spoken languages, the method comprising: obtaining a script for the speaking character in a first language; automatically translating the script into one or more second languages; performing text-to-speech processing to generate a localized audio sample for the script in each of the first language and the one or more second languages; determining a duration of the localized audio sample in each of the first language and the one or more second languages; and determining a maximum spoken duration of the script as the maximum of the respective durations of the localized audio sample in each of the first language and the one or more second languages.

Herein a scene can be any period in which a character is speaking, and scenes need not be defined by a location of the character or by the content of what is being spoken. A “scene” may for example comprise a single line of dialogue, or even part of a line of dialogue.

In simple cases, the maximum spoken duration may be determined as the required length of the scene. Alternatively, the required length of the scene may be determined based on the maximum spoken duration (and optionally based on additional factors). For example, when the scene comprises other elements such as multiple speaking characters or pauses before and after speech, the required length of the scene may be a composite of multiple durations.

By automatically determining the maximum spoken duration of a script across the supported languages, other media components intended to accompany the speech can be configured to support localization. For example, a video game can be configured to focus a virtual camera viewpoint on the speaking character for long enough for the character to complete the scene regardless of the language. Similarly, in live-action media, actors can be directed to perform a scene in a way that allows time for localized dialogue.

The method may further comprise generating an animated scene based on the maximum spoken duration of the script. In dynamic media such as video games, some degree of automatic animation is often required so that the animation can respond to user inputs. By automatically determining the maximum duration of a scene, animation can be more suitably configured to accommodate localized dialogue. Similarly, in fixed animation (i.e. fully scripted animation that does not depend on user interaction), the animation can be generated more efficiently if the maximum spoken duration is known in advance.

The method may further comprise, after determining the maximum spoken duration of the script, obtaining a voice recording of a voice actor performing the script in the first language and/or one or more of the second languages. This has the advantage that the maximum spoken duration is available information at the time of working with the voice actor, such that their performance can be adapted to better match the maximum spoken duration.

In some embodiments, the animated scene comprises an animation of the speaking character. Alternatively, the animated scene may, for example, comprise a voiceover without the character appearing visually. Optionally, the animated scene comprises a video game scene.

The animation of the speaking character may be synchronized to the localized audio sample or a voice recording of the script in at least one of the first language and the one or more second languages.

In some embodiments, one of the first language and the second languages is a faster language for which the duration of the localized audio sample is less than the maximum duration, and the method further comprises: generating an extended script in the faster language by adding one or more pauses or filler words to the script in the faster language; generating an extended localized audio sample in the faster language by adding one or more pauses or filler words to the localized audio sample in the faster language; or generating an extended voice recording in the faster language by adding one or more pauses or filler words to a voice recording of the script in the faster language. In other words, a translated script, a localized audio sample or a voice recording may be adapted based on knowing the maximum spoken duration. For example, a duration of the extended script, extended localized audio sample or extended voice recording may be similar to the maximum spoken duration of the script.

In some embodiments, the method is implemented at runtime of a video game.

According to a second aspect, there is provided a computer-implemented system for determining a required length of a scene comprising a speaking character, wherein the scene is localized in multiple spoken languages, the apparatus comprising: obtaining means configured to obtain a script for the speaking character in a first language; scene length determining means configured to: automatically translate the script into one or more second languages; perform text-to-speech processing to generate a localized audio sample for the script in each of the first language and the one or more second languages; determine a duration of the localized audio sample in each of the first language and the one or more second languages; and determine a maximum spoken duration of the script as the maximum of the respective durations of the audio sample in each of the first language and the one or more second languages.

For example, the second aspect may be implemented using a processing apparatus configured to read instructions and provided with instructions defining a method according to the first aspect. Alternatively the second aspect may be implemented using computer hardware adapted to perform a method according to the first aspect.

The system of the second aspect may further comprise: scene generating means configured to generate an animated scene based on the maximum spoken duration of the script. Optionally, the system may further comprise: second obtaining means configured to, after determining the maximum spoken duration of the script, obtain a voice recording of a voice actor performing the script in the first language and/or one or more of the second languages. As a further option, the animated scene comprises an animation of the speaking character. Optionally, the animated scene comprises a video game scene. For example, the animation of the speaking character may be synchronized to the localized audio sample or a voice recording of the script in at least one of the first language and the one or more second languages.

In the system of the second aspect, one of the first language and the second languages may be a faster language for which the duration of the localized audio sample is less than the maximum spoken duration, wherein the system further comprises an extending means configured to: generate an extended script in the faster language by adding one or more pauses or filler words to the script in the faster language; generate an extended localized audio sample in the faster language by adding one or more pauses or filler words to the localized audio sample in the faster language; or generate an extended voice recording in the faster language by adding one or more pauses or filler words to a voice recording of the script in the faster language. In some examples, a duration of the extended script, extended localized audio sample or extended voice recording is similar to the maximum spoken duration of the script.

According to a further aspect, there is provided a computer-implemented system for determining a required length of a scene comprising a speaking character, wherein the scene is localized in multiple spoken languages, the system comprising a processor configured to: obtain a script for the speaking character in a first language; automatically translate the script into one or more second languages; perform text-to-speech processing to generate a localized audio sample for the script in each of the first language and the one or more second languages; determine a duration of the localized audio sample in each of the first language and the one or more second languages; and determine a maximum spoken duration of the script as the maximum of the respective durations of the audio sample in each of the first language and the one or more second languages. Optionally, the processor is configured to perform the aforestated functions at runtime of video game.

In some embodiments, the processor is further configured to generate an animated scene based on the maximum spoken duration of the script. Optionally, the animated scene comprises a video game scene and/or an animation of the speaking character. Additionally, the animation of the speaking character may be synchronized to the localized audio sample or a voice recording of the script in at least one of the first language and the one or more second languages.

In some embodiments, the processor is further configured to, after determining the maximum spoken duration of the script, obtain a voice recording of a voice actor performing the script in the first language and/or one or more of the second languages.

In some embodiments, one of the first language and the second language is a faster language for which the duration of the localized audio sample is less than the maximum spoken duration, and the processor is further configured to generate an extended script in the faster language by adding one or more pauses or filler words to the script in the faster language; generate an extended localized audio sample in the faster language by adding one or more pauses or filler words to the localized audio sample in the faster language; or generate an extended voice recording in the faster language by adding one or more pauses or filler words to a voice recording of the script in the faster language. Optionally, a duration of the extended script, extended localized audio sample, or extended voice recording is similar to the maximum spoken duration of the script.

According to a further aspect, there is provided a computer program comprising instructions which, when executed by one or more processors, cause the processors to perform a method according to the first aspect.

According to a further aspect, there is provided a non-transitory storage medium storing instructions which, when executed by one or more processors, cause the processors to perform a method according to the first aspect.

According to a further aspect, there is provided a data signal comprising instructions which, when executed by one or more processors, cause the processors to perform a method according to the first aspect.

According to a further aspect, there is provided a computer system or computer apparatus, said system or apparatus comprising one or more processors configured to perform a method according to the first aspect.

### BRIEF DESCRIPTION OF DRAWINGS

FIG. 1 is a flow chart schematically illustrating a method for determining a required length of a scene;

FIG. 2 is a flow chart schematically illustrating method steps following determination of a maximum spoken duration of a script;

FIGS. 3A and 3B are flow charts schematically illustrating further method steps following determination of a maximum spoken duration of a script;

FIG. 4 is a block diagram schematically illustrating a system for determining a required length of a scene.

### DETAILED DESCRIPTION

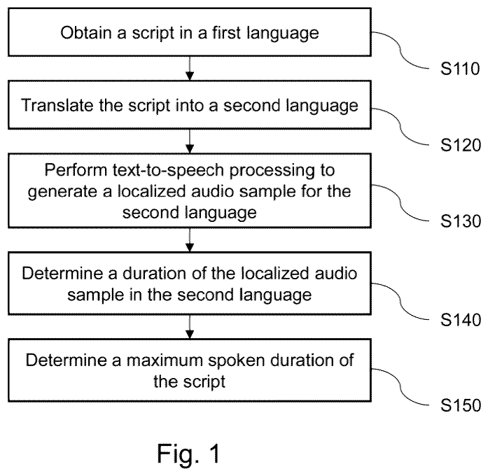

FIG. 1 illustrates key features of a method of determining a required length of a scene.

Although the specification mostly discusses video games, the scene can be part of any media in which one or more characters speak, where localisation of the spoken language is required for different viewers of the media who speak different languages. For example, this method could also be applied before filming live-action media, in order to assist with producing content suitable for dubbing, or for allowing adequate time to read subtitles in different languages.

The method is implemented in a computer-implemented system. For example, the method may be implemented using one or more dedicated ASICs, one or more generic processors executing instructions, one or more memory elements, one or more virtual machines (such as a cloud infrastructure), or any combination of the above.

Referring to FIG. 1, at step S110, the system obtains a script in a first language. For example, a user may indicate a text file in memory comprising the script, and the system may read the text file.

Additionally, the system determines a first language in which the script is provided and determines one or more second languages for which localization support is required. In a simple case, the system may be configured to use one predetermined first language and one or more predetermined second languages, such that there is no “decision” about the languages. Alternatively, the first language and second language(s) may be input by the user. Alternatively, the first language may be automatically detected by the system, and the second language(s) may be automatically selected by the system. In another example, the system may be configured with a predetermined set of localization languages, and may accept a script wherein the first language is one of the localization languages, wherein the second language(s) are the localization languages in the predetermined set other than the first language.

At step S120, the system translates the script from the first language into a second language (i.e. one of the second languages for which localization support is required). This translation may be performed using known natural language processing (NLP) translation techniques, such as a machine-learning model trained to convert first language text to second language text.

At step S130, the system performs text-to-speech processing on the script in the second language to generate a localized audio sample. The localized audio sample is a computer-generated audio recording of the script in the second language. The text-to-speech processing may comprise known NLP techniques, such as a machine-learning model trained to convert second language text to second language audio.

Steps S120 and S130 may be merged. For example, instead of using a first NLP machine-learning model to convert first language text to second language text and a second NLP model to convert second language text to second language audio, a single NLP model may be trained and used to convert first language text into second language audio. Alternatively, NLP models may be trained and used to convert first language text into language-neutral tokens, and to convert language-neutral tokens into second language audio.

At step S140, the system determines a duration of the localized audio sample in the second language. This duration may simply be metadata of the localized audio sample generated in step S130.

Steps S120 to S140 may be further merged. For example, instead of using a second NLP model to convert second language text to second language audio, an NLP model may be trained to directly convert second language text (or first language text or language-neutral tokens) to a duration of the localized audio sample in the second language (without actually generating the localized audio sample in the second language). This may represent an efficiency improvement once the relevant models have been trained, but it is less likely that this can be implemented with off-the-shelf NLP models.

Steps S120 to S140 may be repeated for each second language for which localization is required (if there is more than one).

Additionally, the system performed steps S130 and S140 for the first language to obtain a duration of the localized audio sample in the first language.

At step S150, the system determines a maximum spoken duration of the script. That is, the system determines a maximum duration out of the respective durations determined in step S140 for different languages.

The method of steps S110 to S150 may be performed on an entire script, or the script may be subdivided. For example, a maximum spoken duration may be determined for each line of a script.

The maximum spoken duration of the script, determined in step S150, is indicative of how much time should be provided in the scene for the script to be spoken, regardless of localization. For example, where an animated scene switches its camera point of view between several characters depending on who is speaking, the time focusing on each character, and/or a time between triggering successive lines of dialogue, may be configured based on maximum spoken durations of the relevant lines.

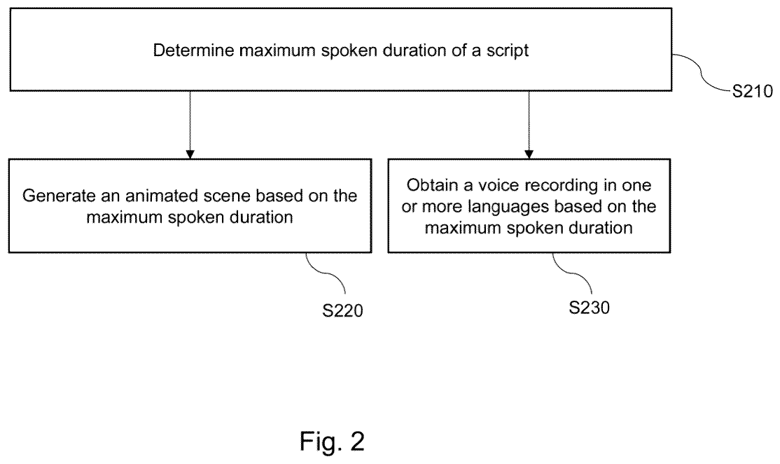

FIG. 2 is a flow chart illustrating alternative ways the maximum spoken duration for a script can be used once it has been determined.

Step S210 corresponds to the method of FIG. 1, as discussed above.

Step S220 illustrates a first option for using the maximum spoken duration. In this option, the system generates an animated scene based on the maximum spoken duration. For example, the maximum spoken duration may be fed into user-interactive animation software, as a constraint for the user designing the scene. Alternatively, the maximum spoken duration may be used as a parameter for automatically generating the animated scene, together with the scene content. Such examples could include where the animated scene is a scene in a video game, the method being used in this way during the development stage of a video game to create cutscenes, sections of dialogue between a user avatar and another speaking character, or other scenes involving in-game characters. Alternatively, the generation of animated scenes in a video game may be performed at runtime of the video game to avoid the storing of redundant information (such as scenes of dialogue in other languages or pertaining to in-game areas/levels not accessible by the given user) in memory. In one example, a virtual camera may automatically be directed at one or more speaking characters in the scene when they are speaking, based on maximum spoken durations calculated for lines of dialogue spoken by each character.

Step 230 illustrates a second option for using the maximum spoken duration. In this option, the system obtains a voice recording of a voice actor performing the script in each of one or more of the languages for which localization support is required (i.e. the first language and second language(s)).

In step S230, the system may compare a duration of the voice actor's performance to the maximum spoken duration. Additionally, the maximum spoken duration may be used by the system or by a human operator to assist with matching the duration of the voice actor's performance to the maximum spoken duration. For example, the system or a human may request a slower performance from the voice actor if the duration of the voice actor's performance is lower than the maximum spoken duration, or the system or human may modify the script such that the duration of a subsequent performance by the voice actor is closer to the maximum spoken duration. Even if such modifications are required, it is expected that the use of the maximum spoken duration is likely to reduce the required changes and to reduce the differences in performances between different languages.

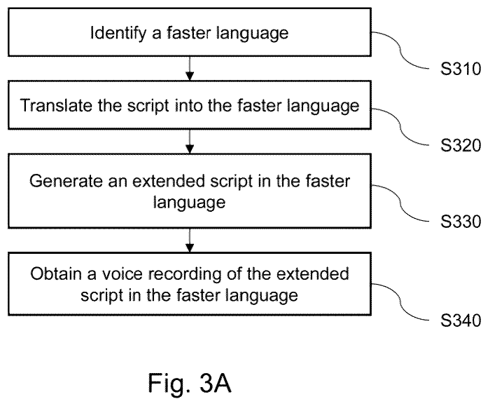

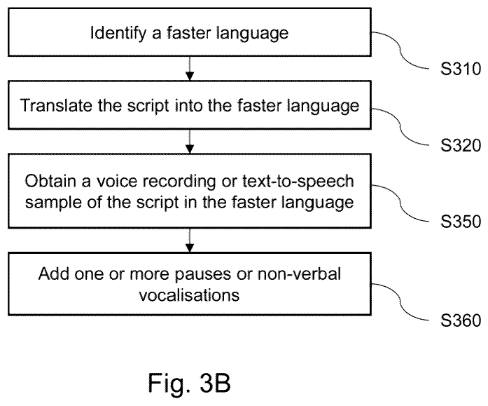

FIGS. 3A and 3B illustrate example implementations of step S230.

Referring to FIG. 3A, at step S310, the system identifies a faster language. The faster language is one of the languages for which localization support is required (i.e. the first language and second language(s)). In the faster language, the duration of the localized audio sample is shorter than the maximum spoken duration. The duration of the localized audio sample is determined as described above with respect to step S140, and the outcome of step S140 may be reused in embodiments where this outcome is saved in memory.

At step S320, the system translates the script into the faster language. Step S320 may be implemented in the same way as described above for step S120, and the outcome of step S120 for the faster language may be reused in embodiments where this outcome is saved in memory.

At step S330, the system generates an extended script in the faster language. In other words, the system modifies the translated script to include additional elements corresponding to an increased spoken duration of the translated script. For example, the system may amend the script to include a direction to pause at a certain point, or may include one or more filler words such as “um”, “ah”, “like” (which may be actual words or may simply represent sounds).

At step S340, the system obtains a localized audio sample or a voice recording similarly to the above-described implementations of step S130 or step S230, the difference being that the voice recording or localized audio sample comprises additional elements of the extended script. This has the effect that the voice recording or localized audio sample in the faster language now better matches the maximum spoken duration.

FIG. 3B is another possible implementation of step S230.

Steps S310 and S320 of FIG. 3B are the same as FIG. 3A. However, the method of FIG. 3B differs in that the “extension” is applied to audio rather than being applied to the translated script.

More specifically, at step S350, the system obtains a localized audio sample or a voice recording similarly to the above-described implementations of step S130 or step S230. This provides a localized audio sample or voice recording of the translated script in the faster language. The outcome of step S130 or S230 for the faster language may be reused if these have been stored, in which case steps S320 and S350 do not require further translation and generation/recording of the audio.

At step S360, the system extends the localized audio sample or voice recording obtained in step S350 to include additional elements corresponding to an increased spoken duration. For example, the system may store sound clips corresponding to one or more of a pause in speech, or a filler word such as “um”, “ah”, “like”. The system may insert one or more sound clips between words in the localized audio sample or voice recording, such that the voice recording or localized audio sample in the faster language now better matches the maximum spoken duration. The system may insert a sound clip randomly or, preferably, inserts the sound clip based on an assessment of the grammatical structure of the recorded script, so that the additional element sounds relatively natural.

Referring again to FIG. 2, steps S220 and S230 may each be performed alone, or may be performed in parallel using respective processing resources and using the maximum spoken duration of the script. For example, if a localized audio sample generated in step S130 (forming part of step S210) is good enough to use in the animated scene, then step S230 may be unnecessary. Alternatively, in a case where the scene comprises audio only, then step S220 may be omitted, and the maximum spoken duration may simply be used to increase uniformity of voice performances in different languages.

In some embodiments, the animated scene generated in step S220 comprises an animation of a speaking character performed by the voice actor in step S230. Such a scene may be a scene in a video gaming scenario wherein an in-game character is voice acted, such as a cutscene shown to the user when they reach a particular point in the game, or when they level up or down. Alternatively, it may be a scene comprising a section of dialogue between a user and a particular speaking character, such as when the user is faced with a number of subsequent selectable options to progress in a game and the character (i.e. the speaking character giving the user said options) speaks back to the user based on the user's selected responses. The dialogue between the player and the in-game character thereby serves to advance the storyline, provide context to the player's actions, and increase the sense of immersion in the in-game environment. The interaction between the player and the in-game character in this way also allows the player to engage with the narrative and make choices that affect the outcome of said storyline.

Nevertheless, it is difficult to provide feedback between the animator and voice actor, especially when localization into multiple languages requires individual performances of the same script by multiple voice actors. A common maximum spoken duration used as input to both of the steps S220 and S230 can assist with synchronizing the voice performance to the animated scene (at least in the first language). This can be enhanced by increasing the granularity at which the maximum spoken duration is calculated (e.g. calculating the maximum spoken duration for individual lines or phrases rather than multi-line scripts).

Steps S220 and S230 may each be performed on computing devices that are separate from a computing device that performed step S210. For example, an animator and a recording studio may each have respective computer apparatus configured to receive the maximum spoken duration of the script.

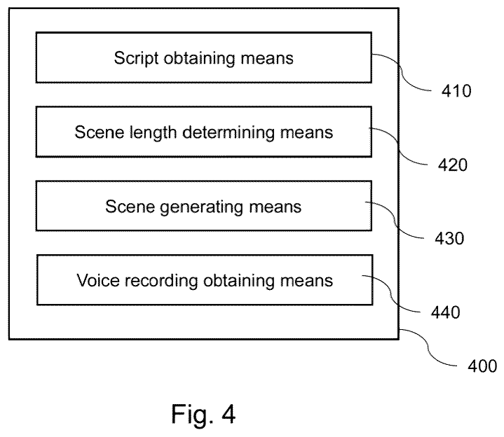

FIG. 4 illustrates an example system in which the above-described methods may be implemented.

The system 400 comprises a script obtaining means 410, a scene length determining means 420, a scene generating means 430 and a voice recording obtaining means 440.

Each “means” of system 400 may, for example, comprise a processor and a memory, wherein the memory stores instructions defining a computer program, such that the “means” is configured to perform the steps of the computer program.

Additionally, each “means” of system 400 may be distributed as computer instructions, either on a storage medium (CD, flash memory etc.) or via a signal (network connection). Once distributed to a computer device, the computer instructions may be stored in a memory and executed by a processor.

The scene obtaining means 410 is configured to perform step S110 as described above to obtain a script in a first language. For example, the scene obtaining means 410 may obtain the script via a network or via a user interface, or obtain the script from a memory. For example, the scene obtaining means 410 may be implemented in the client part of a client-server arrangement for a service for determining a required length of a scene.

The scene length determining means 420 is configured to perform steps S120 to S150 as described above. For example, the scene length determining means 420 may be implemented in the server part of the client server arrangement for a service for determining a required length of a scene. Placing the scene length determining means 420 in a server may prevent customers from having direct access to trained models used in steps S120 to S150, and may increase portability of the service.

The scene generating means 430 is configured to perform step S220 as described above. For example, the scene generating means 430 may be implemented in the client part of the client-server arrangement for a service for determining a required length of a scene.

The voice recording obtaining means 440 is configured to perform step S230 (and optionally perform one of the methods of FIGS. 3A and 3B). For example, the voice recording obtaining means 440 may be partially implemented in each of a client and server part of a client-server arrangement for a service for determining a required length of a scene. In particular, instructions for steps S310 to S330 and S360 may preferably be implemented in the server.

Any such means and any of the method steps described hitherto may be implemented at runtime of a video game. For example, while a player is progressing through a game, depending on the different milestones reached, the different in-game areas accessed by said player within the game environment, and user preferences such as the preferred language set by the player prior to entering the level, different scripts will be required and therefore different spoken durations will need to be calculated. To avoid utilising large portions of memory storing each possible section of dialogue in each available language, it is possible to implement the obtaining of scripts and subsequent determination of a maximum duration of a script for a given scene at runtime of the video game. In the context of computer game processing scenarios, “runtime” typically refers to the period during which the game is actively running and rendering frames in real-time. During runtime, various tasks such as loading assets, executing game logic, rendering audio and graphics, and handling user inputs are performed continuously to provide an interactive gaming experience and to remove the need to store redundant information in memory. In one possible implementation, the processing at runtime may be carried out on a virtual machine i.e. using processors in cloud infrastructure such as in a cloud gaming scenario.

1. A computer-implemented method for determining a required length of a scene comprising a speaking character, wherein the scene is localized in multiple spoken languages, the method comprising:
obtaining a script for the speaking character in a first language;
automatically translating the script into one or more second languages;
performing text-to-speech processing to generate a localized audio sample for the script in each of the first language and the one or more second languages;
determining a duration of the localized audio sample in each of the first language and the one or more second languages; and
determining a maximum spoken duration of the script as a maximum of the respective durations of the localized audio sample in each of the first language and the one or more second languages.

2. The method according to claim 1, further comprising generating an animated scene based on the maximum spoken duration of the script.

3. The method according to claim 2, wherein the animated scene comprises a video game scene.

4. The method according to claim 2, further comprising, after determining the maximum spoken duration of the script, obtaining a voice recording of a voice actor performing the script in at least one of the first language or one or more of the second languages.

5. The method according to claim 2, wherein the animated scene comprises an animation of the speaking character.

6. The method according to claim 5, wherein the animation of the speaking character is synchronized to the localized audio sample or a voice recording of the script in at least one of the first language or one or more of the second languages.

7. The method according to claim 1, wherein one of the first language or the one or more second languages is a faster language for which the duration of the localized audio sample is less than the maximum duration.

8. The method according to claim 7, further comprising at least one of:
generating an extended script in the faster language by adding one or more pauses or filler words to the script in the faster language;
generating an extended localized audio sample in the faster language by adding one or more pauses or filler words to the localized audio sample in the faster language; or
generating an extended voice recording in the faster language by adding one or more pauses or filler words to a voice recording of the script in the faster language.

9. The method according to claim 8, wherein a duration of the extended script, extended localized audio sample, or extended voice recording is similar to the maximum spoken duration of the script.

10. The method according to claim 1, wherein the method is implemented at runtime of a video game.

11. A computer apparatus comprising one or more processors configured to perform the method of claim 1.

12. A computer-implemented system for determining a required length of a scene comprising a speaking character, wherein the scene is localized in multiple spoken languages, the system comprising a processor configured to:
obtain a script for the speaking character in a first language;
automatically translate the script into one or more second languages;
perform text-to-speech processing to generate a localized audio sample for the script in each of the first language and the one or more second languages;
determine a duration of the localized audio sample in each of the first language and the one or more second languages; and
determine a maximum spoken duration of the script as the maximum of the respective durations of the audio sample in each of the first language and the one or more second languages.

13. The system according to claim 12, wherein the processor is further configured to generate an animated scene based on the maximum spoken duration of the script.

14. The system according to claim 13, wherein the animated scene comprises a video game scene.

15. The system according to claim 12, wherein the processor is further configured to, after determining the maximum spoken duration of the script, obtain a voice recording of a voice actor performing the script in at least one of the first language or one or more of the second languages.

16. The system according to claim 12, wherein the animated scene comprises an animation of the speaking character.

17. The system according to claim 16, wherein the animation of the speaking character is synchronized to the localized audio sample or a voice recording of the script in at least one of the first language or one or more of the second languages.

18. The system according to claim 12, wherein one of the first language or the one or more second languages is a faster language for which the duration of the localized audio sample is less than the maximum spoken duration and the processor is further configured to:
generate an extended script in the faster language by adding one or more pauses or filler words to the script in the faster language;
generate an extended localized audio sample in the faster language by adding one or more pauses or filler words to the localized audio sample in the faster language; or
generate an extended voice recording in the faster language by adding one or more pauses or filler words to a voice recording of the script in the faster language.

19. The system according to claim 18, wherein a duration of the extended script, extended localized audio sample, or extended voice recording is similar to the maximum spoken duration of the script.

20. The system according to claim 12, wherein the processor is further configured to perform the determining a required length of a scene at runtime of a video game.
